(19) United States
(12) Patent Application Publication
(10) Pub. No.: US 2015/0183626 A1
(43) Pub. Date: Jul. 2, 2015

(54) PROCESS FOR BOTTLING A MIXED BEVERAGE INTO A GLASS

(71) Applicant: Tresa Glenn Protzman, Toluca Lake, CA (US)

(72) Inventor: Tresa Glenn Protzman, Toluca Lake, CA (US)

(21) Appl. No.: 14/581,261

(22) Filed: Dec. 23, 2014

Related U.S. Application Data
(60) Provisional application No. 61/922,928, filed on Jan. 2, 2014.

(51) Int. Cl. B67C 3/02; B67B 3/02

(52) U.S. Cl. CPC B67C 3/026; B67B 3/026

(57) ABSTRACT

A process for making and consuming a single serving mixed beverage includes the following steps. First, filling a container having an upper lip with a single serving mixed beverage. Next, sealing the container with a container seal covering the upper lip and having a pull ring extend outside of the container. After that, covering the container and the seal with a lid.

### RELATED APPLICATION

This application claims priority to provisional patent application U.S. Ser. No. 61/922,928 filed on Jan. 2, 2014, the entire contents of which is herein incorporated by reference.

### BACKGROUND

The embodiments herein relate generally to bottling beverages.

Prior to embodiments of the disclosed invention, pre-mixed liquor cocktails and non-alcohol beverages were currently not bottled directly into re-sealable drinking glass containing individual servings. Embodiments of the disclosed invention solve that problem.

### SUMMARY

A process for making and consuming a single serving mixed beverage includes the following steps. First, filling a container having an upper lip with a single serving mixed beverage. Next, sealing the container with a container seal covering the upper lip and having a pull ring extend outside of the container. After that, covering the container and the seal with a lid.

In some embodiments, sealing the container can further include the following steps. First, applying an eddy current to the container seal. Then, melting the container seal onto the upper lip.

In some embodiments, the process further includes removing the lid. Then, removing the container seal. In some embodiments, removing the container seal can involve pulling a pull ring attached to the container seal. After that, replacing the lid onto the container.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of an embodiment of the invention.

FIG. 2 is an exploded view of an embodiment of the invention.

FIG. 3 is a section view of an embodiment of the invention, taken along line 3-3 in FIG. 1.

FIG. 4 is a detail section view of an embodiment of the invention.

FIG. 5 is a perspective view of an embodiment of the invention with the lid removed, illustrating the removal of the seal.

FIG. 6 is a perspective view of an embodiment of the invention.

FIG. 7 is a perspective view of an embodiment of the invention.

### DETAILED DESCRIPTION OF CERTAIN EMBODIMENTS

A mixed beverage is a beverage in which two or more ingredients are mixed. Some mixed beverages contain liquor; others are non-alcoholic. This includes cocktails, mixed beverage shooters and drink shots, beer cocktails, wine cocktails and punches, and non-alcoholic mixed beverages. Cocktails are one or more distilled spirits combined with drink mixers. Mixed beverage shooters and drink shots are small servings of cocktails in special glasses. Beer cocktails combine beer with a drink mixer or distilled spirits. Wine cocktails and punches, combine wine (still or sparkling) with drink mixers. Non-alcoholic mixed beverages are soft drinks that do not contain alcohol. A single serving mixed drink is typically 4 to 12 ounces of fluid and comprises two or more ingredients at least one of which is a liquid at standard ambient temperature and pressure which is understood to be 298.15 K and an absolute pressure of 100 kPa.

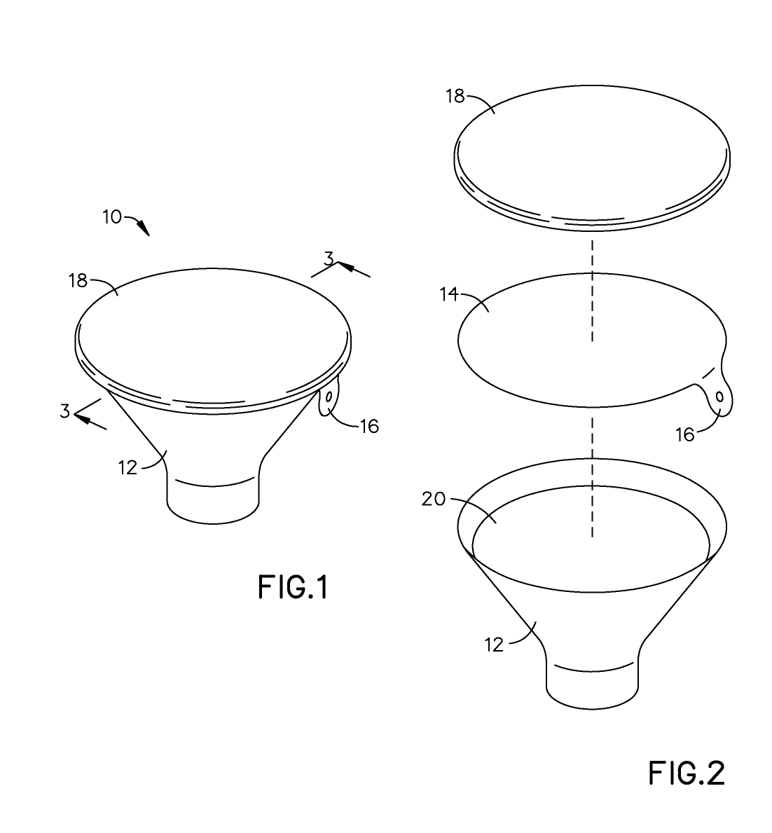

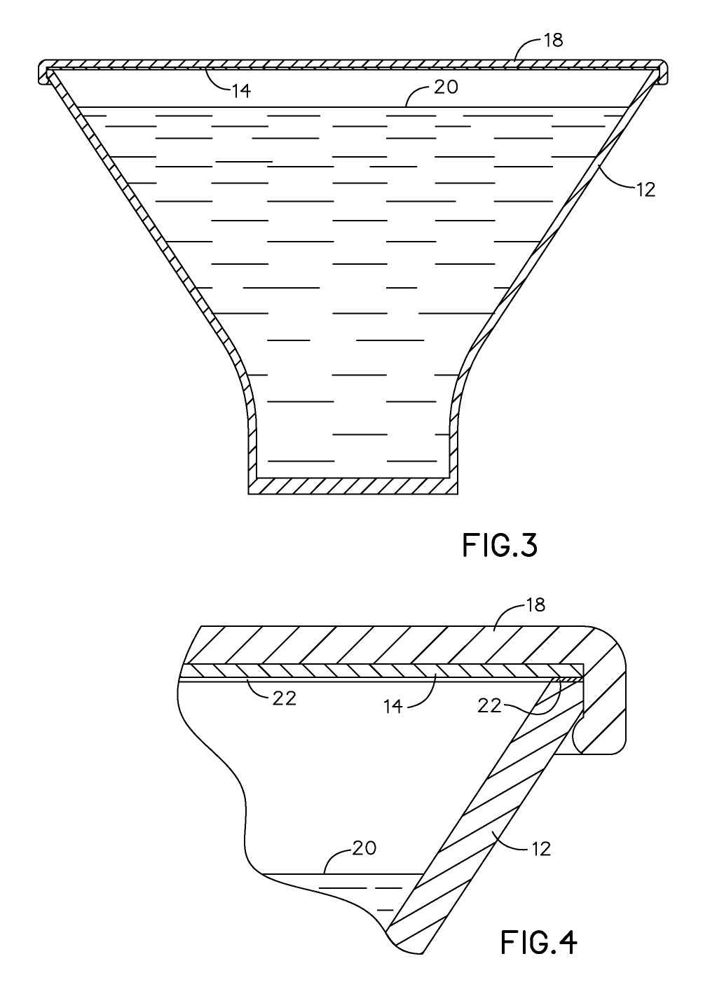

By way of example, and referring to FIG. 1, FIG. 2, and FIG. 3, one embodiment of individually packaged mixed beverage 10 comprises container 12 which is partially filled with mixed beverage 20. Container 12 has an upper lip which is mechanically coupled to container seal 14. Container seal 14 is mechanically coupled to pull ring 16. Pull ring 16 is effective for removing container seal 14 from the upper lip. Container seal 14 is covered with lid 18, however, lid 18 need not cover pull ring 16. Pull ring 16 can be made sufficiently strong to remove lid 18 when elevated. This provides the ability to remove the lid and container seal in a single step. In some embodiments, once container seal 14 is removed from container 12, lid 18 can be replaced which continues to cover mixed beverage 20. In other embodiments, lid 18 is removable but not replaceable.

Turning to FIG. 4, container seal 14 is bonded to container 12 with induction seal 22. In some embodiments induction seal 22 can be used when container seal 14 is polyethylene terephthalate (PET) with a foil laminate inner seal when container 12 is either made from glass or plastic. The induction sealing process bonds a container seal 14 to the lip of container 12. After container 12 has been filled and capped with an induction-lined closure, it passes underneath the induction sealing system. The non-contact heating process welds the liner to the container creating a hermetic seal. The Food and Drug Administration regards induction sealing to be an effective method of tamper evidence.

An induction sealing machine features two standard components: the power supply and sealing head. The sealing head consists of a coiled conductor covered by plastic housing. When the power supply energizes the inductive coil, it produces an electromagnetic current, called an eddy current. When container 12 fitted with an induction lined cap passes through this current, the foil from the inner-seal is heated. This melts the foil's outer polymer coating, which forms a bond with the upper lip of container 12.

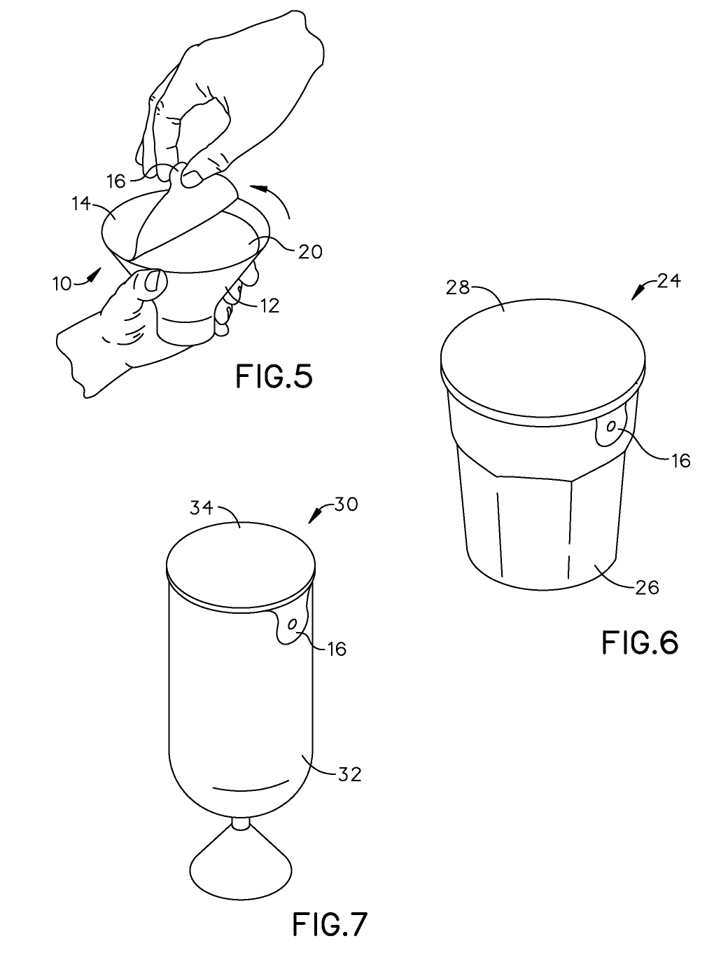

Turning to FIG. 6 and FIG. 7, individually packaged beverage 24, 30 comprises container 26, 32 sealed to a container seal having pull ring 16. The container seal is covered with lid 28, 34. The container can be of any shape, and the lid likewise, so as the lid is capable of covering the container. In some embodiments, a larger container 26, 32 is preferred in order to make room for ice.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A process for making and consuming a single serving mixed beverage; the process comprising:
filling a container having an upper lip with a single serving mixed beverage;
sealing the container with a container seal covering the upper lip and having a pull ring extend outside of the container; and
covering the container and the seal with a lid.

2. The process of claim 1, wherein sealing the container further comprises: applying an eddy current to the container seal and melting the container seal onto the upper lip.

3. The process of claim 2, further comprising removing the lid by elevating the pull ring over the lid detaching the lid from the container.

4. The process of claim 3, further comprises removing the container seal.

5. The process of claim 4, wherein removing the container seal further comprises pulling a pull ring attached to the container seal.

6. The process of claim 5, further comprising replacing the lid onto the container.
